(19) United States
(12) Patent Application Publication
(10) Pub. No.: US 2023/0068006 A1
(43) Pub. Date: Mar. 2, 2023

(54) METAL-AIR BATTERIES

(71) Applicant: DayLyte, Inc., Knoxville, TN (US)

(72) Inventor: Caleb Tyler Alexander, Knoxville, TN (US)

(21) Appl. No.: 17/901,358

(22) Filed: Sep. 1, 2022

Related U.S. Application Data
(60) Provisional application No. 63/327,328, filed on Apr. 4, 2022.
(60) Provisional application No. 63/240,394, filed on Sep. 3, 2021.
(60) Provisional application No. 63/240,389, filed on Sep. 3, 2021.
(60) Provisional application No. 63/239,487, filed on Sep. 1, 2021.
(60) Provisional application No. 63/239,601, filed on Sep. 1, 2021.

(51) Int. Cl. H01M 12/06

(52) U.S. Cl. CPC H01M 12/06

(57) ABSTRACT

Methods of improving an aqueous metal-air battery are disclosed. The methods include forming a solid electrolyte on a conductive substrate; forming a protective surface on the solid electrolyte; having and improving separate oxygen reduction and oxygen evolution electrodes; improving the gas diffusion of the oxygen reduction and evolution electrodes; and improving the structure of the battery cell. Improved metal-air batteries including such improvements are further disclosed.

### CROSS-REFERENCE TO RELATED APPLICATIONS

The present application claims the priority benefit of U.S. Provisional Pat. App. Serial No. 63/239,601, filed Sep. 1, 2021, for an “Aqueous Metal-Air Battery Cell Structure”; U.S. Provisional Pat. App. Serial No. 62/239,487, filed Sep. 1, 2021, for a “Thin Film Ceramic Solid Electrolyte”; U.S. Provisional Pat. App. Serial No. 63/240,389, filed Sep. 3, 2021, for “Thin Film Solid Electrolyte Stability”; U.S. Provisional Pat. App. Serial No. 63/240,394, filed Sep. 3, 2021, for “Aqueous Metal-Air Battery with Stable Oxygen Reduction and Oxygen Evolution Catalysts”; and U.S. Provisional Pat. App. Serial No. 63/327,328, filed Apr. 4, 2022, for “Stable, Low Cost, Active Gas Diffusion Electrodes”; each of which is hereby incorporated by reference herein in their respective entireties.

### GOVERNMENT LICENSE RIGHTS

This invention was made with government support under Small Business Technology Transfer Phase 1 Grant Award DE-SC0022492 awarded by the U.S. Dept. of Energy. The government has certain rights in the invention.

### TECHNICAL FIELD

The present disclosure relates generally to improvements to metal-air batteries which enable improved performance and lifetimes.

### BACKGROUND

Batteries have become increasingly important to the modern world and are used to provide electrical power on scales ranging from watches to continental power grids. Conventional battery chemistries, however, are expected to struggle to satisfy the demand for battery capacity in the near future. For example, electrification of the transportation industry and grid-scale energy storage each require an unprecedented increase in rechargeable battery capacity. Traditional rechargeable battery chemistries including nickel-cadmium (“NiCD”), nickel metal hydride (“NiMH”), lead-acid, and lithium-based (e.g., lithium ion (“Li-Ion”) and lithium iron phosphate (“LiFePO₄”)) batteries each suffer from various issues such as low power density, toxicity, or high cost that make them incapable of providing the necessary battery capacity needed for electrification of the transportation industry or for sufficient grid-scale energy to allow for renewable power generation.

### BRIEF DESCRIPTION OF THE DRAWINGS

FIG. 1A depicts a side view of a solid electrolyte attached to a conductive substrate according to one embodiment.

FIG. 1B depicts a side view of the solid electrolyte of FIG. 1A showing a charge and discharge cycle according to one embodiment.

FIG. 2A depicts a side view of a thin film protective coating on a solid electrolyte according to one embodiment.

FIG. 2B depicts a structural chemical view of the thin film protective coating of FIG. 2A.

FIG. 2C depicts an alternative thin film protective coating on a solid electrolyte according to another embodient.

FIG. 3A depicts a side view of an illustrative aqueous metal-air battery according to one embodiment.

FIG. 3B depicts a side view of an alternative illustrative aqueous metal-air battery according to another embodiment.

FIG. 3C depicts a series of aqueous metal-air battery cells in a parallel charging configuration according to one embodiment.

FIG. 3D depicts a cross section of the negative electrode compartment according to one embodiment.

FIGS. 3E and 3F depict a top view of a metal-air battery negative electrode compartment according to certain embodiments. The oxygen reduction electrode and oxygen evolution electrode are not depicted.

FIG. 4 depicts an illustrative side view of a metal-air battery negative electrode compartment to show details of the internal construction of the battery core according to one embodiment.

FIG. 5 depicts a side view of an asymmetric metal-air battery cell according to one embodiment.

FIGS. 6A to 6G depicts electrochemical data about an example solid electrolyte.

FIGS. 6H to 6K depicts electron microscopy images of the solid electrolyte of FIGS. 6A to 6G.

### DETAILED DESCRIPTION

Metal-air batteries refer to the class of batteries where the positive electrode, or cathode, is exposed to air to reduce oxygen to hydroxides or peroxides and oxidize the hydroxides or peroxides back to oxygen. By replacing the metal cathode with, functionally weightless, ambient air, metal-air batteries can theoretically reach higher specific capacities and higher energy densities than conventional battery chemistries having a metal (oxide) cathode. Table 1 depicts the standard reduction potential vs. the standard hydrogen electrode (“SHE”) for different possible, but not limiting, negative electrodes and the oxygen reduction reaction. Table 1 further reports corresponding charge capacity, and theoretical energy density of the various metal-air batteries. As comparison, the theoretical energy density of a lead acid battery is 170 Wh/kg and a lithium-ion battery 400 to 700 Wh/kg demonstrating the substantially higher theoretical performance of metal-air batteries compared to conventional batteries. As can be appreciated, such theoretical energy densities would enable metal-air batteries to be used in applications hereto impossible to power using known battery chemistries such as battery powered heavier than air flight.

Table 1

| Anode | MW (g/mol) | Electrons | V vs SHE | Charge Capacity (Ah/kg) | Theoretical Energy Density (Wh/kg) |
|---|---|---|---|---|---|
| Li | 6.94 | 1 | -3.04 | 3862 | 2886 |
| Na | 22.99 | 1 | -2.71 | 1166 | 1737 |
| K | 39.1 | 1 | -2.931 | 685 | 1393 |
| Rb | 85.47 | 1 | -2.98 | 314 | 820 |
| Cs | 132.91 | 1 | -3.026 | 202 | 582 |
| Zn (OH) | 134.37 | 2 | -1.199 | 399 | 465 |
| BeO-+2H₂O | 77.05 | 2 | -2.63 | 696 | 1279 |
| Mg (OH)₂ | 58.31 | 2 | -2.69 | 919 | 1529 |
| Ca(OH)₂ | 74.06 | 2 | -3.02 | 724 | 1478 |
| | 97.04 | 3 | -2.33 | 829 | 1276 |
| O₂+2H₂O | 100.04 | 4 | 0.401 | 1072 | 0 |

Despite the vastly higher theoretical energy density of metal-air batteries compared to more traditional battery chemistries, metal-air batteries have been hindered by various issues that have prevented their widespread deployment including poor real-world performance and poor cycling lifetimes. Some of the problems that non-aqueous metal-air batteries suffer from include their air electrodes clogging during discharge from insoluble discharge products, and insulating metal oxide, hydroxides and carbonates forming on the metal anode surface from diffusion of atmospheric oxygen, water vapor and carbon dioxide respectively. Aqueous metal-air batteries tend to suffer from high self-discharge without a protective solid electrolyte or from slow charge-discharge rates due to solid electrolyte being either too thick, having too low of an ionic conductivity and/or having high contact resistances at the solid electrolyte-metal anode interface. The need for active and stable oxygen catalysts is a challenge for both the aqueous and non-aqueous metal-air batteries.

As will be described herein, improvements to metal-air batteries are disclosed as well as metal-air batteries thereof. The improvements enable metal-air batteries to have a long lifespan and to exhibit desirable performance significantly nearer to their theoretical limits particularly when used with aqueous metal-air batteries. The improvements include improved thin film solid electrolyte; improved thin film protective coatings for the solid electrolyte; improved oxygen evolution and oxygen reduction catalysts for the positive electrodes or air cathodes; improved active gas diffusion electrodes; and improved aqueous metal-air battery cell structures.

Although the improvements described herein are described with respect to metal-air batteries, it should be appreciated that such improvements can have utility in other applications. For example, improvements described herein relating to the oxygen evolution and reduction catalysts and the active gas diffusion electrodes can be useful for fuel cells, the chlor-alkali process, and other electrolytic processes. Similarly, improvements to the solid electrolyte and solid electrolyte protective surfaces have wide utility in applications subject to highly corrosive conditions including various protective coatings, desalination films, sensors, containers, and the like. Such further applications are expressed contemplated herein and are considered within the scope of this application.

Generally, the improvements to metal-air batteries and metal-air batteries thereof described herein can be widely applied to all known metal-air battery chemistries. For example, the improvements described herein can be applied to alkali metal-air batteries, alkaline earth metal-air batteries, and first-row transition metal-air batteries. More specifically, but without limitation, the improvements described herein can apply to sodium air batteries, lithium air batteries, iron air batteries, potassium air batteries, zinc air batteries, magnesium air batteries, calcium air batteries, aluminum air batteries, tin air batteries, or germanium air batteries. In certain embodiments, the improvements can be particularly applicable to aqueous metal-air batteries having an alkali metal anode.

### Solid Electrolyte

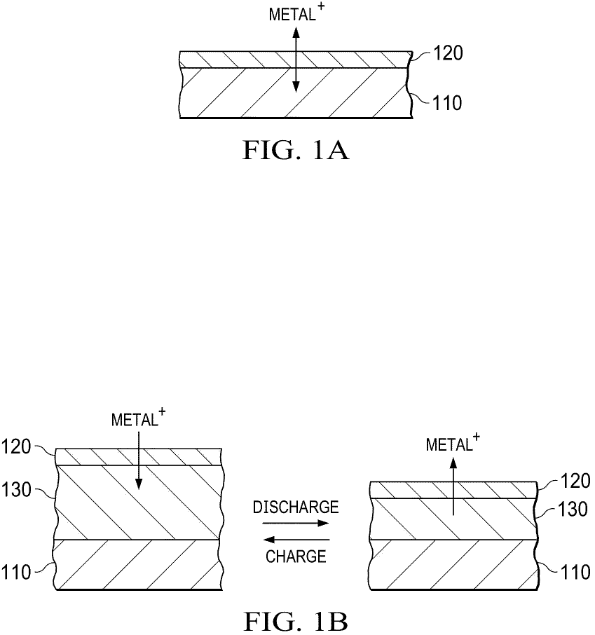

In certain embodiments described herein, an improved solid electrolyte is disclosed. The solid electrolyte is an ionically conductive layer or film that is impermeable to water and oxygen which separates the anode and cathode while allowing for ionic charge carriers to pass. As can be appreciated, the solid electrolyte needs to simultaneously be both durable and thin as any damage to the separator will cause failure of a battery while a thicker separator increases electrical resistance and lowers the performance of a battery. The improved solid electrolyte disclosed herein improves upon known solid electrolytes by being directly attached to a conductive substrate which provides inherently perfect, or nearly perfect, metal-solid electrolyte interface contact and additional mechanical strength and durability to the solid electrolytes compared to the self-supporting solid electrolytes or separators of known metal-air batteries. Such attachment can also increase the efficiency of the battery by minimizing the distance the ionic charge carriers need to transport thereby reducing ionic resistance. FIG. 1A depicts the improved solid electrolyte 120 attached to a conductive substrate 110.

In certain embodiments, the conductive substrate can be formed on the negative electrode, or anode, of a metal-air battery. However, in other embodiments, the solid electrolyte can alternatively be formed on a different conductive material including, without limitation, stainless steel, copper, or aluminum. In such embodiments, such conductive materials can be the current collector of a metal-air battery meaning the battery would be assembled in the discharged state in what is described as an ‘anode-less’ design. After assembly of the metal-air battery, charging of the battery can electroplate the ions of interest onto the anode between the solid electrolyte and the conductive substrate to complete the battery. Such embodiments are particularly desirable as the solid electrolyte generates excellent conformal contact with the anode decreasing electrical contact resistance and avoiding risks associated with assembling an aqueous battery with an alkali metal.

Operation of a metal-air battery is depicted in FIG. 1B which illustrates charging and discharging of a sodium air battery anode. As depicted in FIG. 1B, during charging, sodium-ions migrate through the solid electrolyte 120 to electrodeposit onto the conductive substrate 110 and thereby form the metal anode 130. During discharging, the loss of an electron leads to the formation of a sodium ion which migrates through the solid electrolyte 120 into the electrolyte solution. As can be appreciated, similar redox reactions occur for other metal-air batteries. For example, lithium and lithium hydroxide replace the sodium and sodium hydroxide for a lithium air battery.

The thinness of the solid electrolytes described herein can make defects less energetically favorable to form which grants the solid electrolyte higher mechanical strength and flexibility while attachment to a conductive substrate can provide the solid electrolyte a perfect, or nearly perfect, solid-solid interface. Such properties can enable the solid electrolyte to be extremely thin. For example, in various embodiments, the solid electrolyte can have a thickness of about 100 microns or less, about 50 microns or less, about 10 microns or less, about 3 microns or less, about 1 micron or less, about 500 nanometers or less, about 300 nanometers or less, or even about 100 nanometers or less. Additionally, the solid electrolyte can be more resistant to mechanical damage as it is less likely to be damaged by physical movement of the metal-air battery than a conventional solid electrolyte that is not permanently attached to a conductive substrate. The ionic resistance of the solid electrolyte can be less than about 10 Q/cm² in certain embodiments improving the efficiency of the battery. For example, in certain embodiments, the ionic resistance can be about 0.1 Q/cm² to about 10 Q/cm², about 0.25 Q/cm² to about 5 Q/cm², or about 0.5 Q/cm² to about 3 Ω/cm² . As can be appreciated, such ionic resistances are very low improving the efficiency of the batteries described herein. A comparative lithium-ion battery can have an ionic resistance of about 20 Q/cm² to about 25 Ω/cm²

In certain embodiments, the solid electrolyte can be formed as a single layer. In other embodiments, the solid electrolyte can be built up of multiple layers. In certain such embodiments, the layers can be the same or can be formed of different materials.

Generally, the solid electrolyte can be formed of any suitable material that can allow ions to transit the separator while being impenetrable to water and oxygen. In certain embodiments, such materials can be a ceramic material while in other embodiments, such materials can alternatively, or additionally, be polymeric materials. Examples of suitable ceramic materials include sodium beta-alumina, potassium beta-alumina, lithium beta-alumina, Nasicon-type, Lisicon-type, garnet-type, perovskite-type, NaPON and LiPON-type, Li3N-type, Na₃N-type, argyrodite-type, anti-perovskite type ceramics, phosphate ceramics (Li/Na/K/Rb/Cs/Fr)₃PO₄, and borate ceramics (Li/Na/K/Rb/Cs/Fr)₃BO₃.

As can be appreciated, Nasicon-type and Lisicon-type ceramics refer to sodium super ionic conductor and lithium super ionic conductor respectively. Such conductors are known for having extremely high ionic conductivity (e.g., on the order of 10⁻³ S/cm at room temperature) while remaining impermeable to water and oxygen. For sodium air batteries, Nasicon-type ceramics are particularly useful as they have very high ionic conductivity to sodium ions while for lithium air batteries, Lisicon-type ceramics can be more useful.

Suitable ceramics within such classes can vary widely. For example, suitable Nasicon-type compositions can have the chemical formula AxMₐM’₂₋ₐ(XO₄)₃ where A is one or more of Li⁺, Na⁺, K⁺, Rb⁺, Cs⁺, Mg²⁺, Ca²⁺, Sr²⁺, Ba²⁺, H⁺, H₃O⁺, NH₄⁺, Cu⁺, Cu²⁺, Ag⁺, Pb²⁺, Cd²⁺, Mn²⁺, Co²⁺, Ni²⁺, Zn²⁺, Al³⁺, Ln³⁺ (Ln=rare earth), Ge⁴⁺, Zr⁴⁺, Hf⁴⁺ or vacant; M or M′ is one or more of di (Zn²⁺, Cd²⁺, Ni²⁺, Mn²⁺, Co²⁺), tri (Fe³⁺, Sc³⁺, Ti³⁺, V³⁺, Cr³⁺, Al³⁺, In³⁺, Ga³⁺, Y³⁺, Lu³⁺), tetra (Ti⁴⁺, Zr⁴⁺, Hf⁴⁺, Sn⁴⁺, Si⁴⁺, Ge⁴⁺) and penta (V⁵⁺, Nb⁵⁺, Ta⁵⁺, Sb⁵⁺, As⁵⁺) valent transition metal ions to balance the charge suitably; X is one or more of S, P, Si, As, Ge, Se; and wherein oxygen can be substituted for S (i.e. XS₄). Generally, Nasicon-type ceramics can have a variety of crystalline geometries including rhombohedral, monoclinic, triclinic, orthorhombic, langbeinite, garnet, sw type (orthorhombic scandium wolframate Sc₂(WO₄)₃), corundum-like and amorphous crystal structures.

In certain embodiments where the metal-air battery is a sodium air battery, a particularly suitable Nasicon is Na₁₊ₓZr₂P₃₋ₓSiₓO₁₂ (0≤x≤3) and in particular where x is between about 2 about 2.2 as this exhibits the highest sodium ion conductivity. In certain embodiments, the foregoing Nasicon can further substitute up to about 0.2 Zr with one or more of Sr, Y, Zn, Mg, Ca, Ni, Co, LA, and Fe.

Suitable Lisicon-type ceramics can have the formula Li₂₊₂ₓZn₁₋ₓGeO₄. Specific examples of suitable Lisicon-type ceramics include those having the formula (1-x)Li₂S-(x)P₂S₅ (0≤x≤1); Li₄₋ ₓGe₁₋ₓPₓS₄ (0<x<1); Li₂GeS₃, Li₄GeS₄, Li₂ZnGeS₄, Li₄₋₂ₓZnₓGeS₄ (0≤x≤0.2), Li₅GaS₄ and Li_{4+x+δ}(Ge_{1-δ'-x}Gaₓ)S₄;(Li₄₋ₓSi₁₋ₓPₓS₄, Li₄₋₂ₓZnₓGeS₄, Li₄₋ₓGe₁₋ₓPₓS₄) vacancy doped' (Li₄₊ₓSi₁₋ₓ AlₓS₄, Li₄₊ₓGe₁₋ₓGaₓS₄ ) interstitial doped; Li₁₀GeP₂S₁₂; Li_{10±1}MP₂X₁₂ wherein M is one or more of Ge, Si, Sn, Al, P; and X is one or more of O, S, and Se; 0.33[(_{1-y})B₂S₃-_{y}P₂S₅]-0.67Li₂S (0 ≤ y ≤ 0.3, 0.9 ≤ y ≤ 1.0); Li₇PS₆; Li₃PS₄; and Li₄P₂S₆.

Suitable garnet-type ceramics can have the chemical formula A₇B₃M₂O₁₂ wherein A is one or more of Li, Be, Fe, Zn Ga, Al, B, Br, Ag; B is one or more of Na, K, Rb, Ca, Sr, Ba, Y, Bi, Pr, Nd, Pm, Sm, Gd, Tb, Dy, Ho, Er, Tm, Lu, Ac; and M is one or more of Mg, Sc, Ti, V, Cr, Mn, Fe, Co, Ni, Cu , Nb, Zr, Nb, Mo, Tc, Ru, Rh, Pd, Ag, Cd, Hf, Ta, W, Ir, Pt, Au, Hg, Ce, Eu, Th, Pa, Np, Pu, C, Si, Ge, As, S, Cl, Se, In, Sn, Sb, Te, I, Tl, and Pb. For example, a suitable garnet-type ceramic is Li₇La₃Zr₂Oₗ₂. In certain embodiments, garnet-type ceramics can be doped with aluminum.

Suitable perovskite-type ceramics can have the chemical formula ABC₃ wherein A is one or more of H, Li, Na, K, Rb, Cs, Fr, Be, Mg, Ca, Sr, Ba, Ra, Sc, Y, and Ln (rare earth elements); B is a transition metal (e.g., Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, or Hg); and C is one or more of H, C, N, O, F, S, Cl, As, Se, Br, I, Rh, and Pd.

Suitable NaPON— and LiPON— type ceramics are lithium or sodium phosphorus oxynitride having an amorphous crystalline geometry.

Suitable Li₃N-type ceramics can have the formula A₃N wherein A is an alkaline metal such as lithium, sodium, potassium, cesium, or rubidium. Suitable Na₃N-type ceramics can have the chemical formula A₃N-AB wherein A is an alkaline metal such as lithium, sodium, potassium, cesium, or rubidium and B is a halogen such as fluorine, chlorine, bromine, or iodine.

Suitable argyrodite-type ceramics include Li₆PS₅X wherein X is Cl, Br, or I and where Li could also be Na, K, Rb, Cs, Fr; Li₆PO₅X wherein X is Cl, Br, or I and where Li could also be Na, K, Rb, Cs, Fr; and Li₂ₓSiP₂S₇₊ₓ (10 < x < 12) where Li could also be Na, K, Rb, Cs, or Fr.

Suitable anti-perovskite ceramics can have the chemical formula ABX₃ where A is a halogen or mixture of halogens (F⁻, Cl⁻, Br⁻, I⁻, At⁻, or BH₄); B is oxygen or sulfur and X is Li, Na, K, Rb, Cs,or Fr. Anti-perovskite ceramics can also be doped with metals having a valence of 2+ including magnesium, calcium, and barium. Other suitable anti-perovskite ceramics can have the chemical formula X₄BA₂ wherein X is Li or Na, B is O or S, and A is Cl, Br, or I; Na₃NO₃; Na₃OCN; and X₃BA wherein X is Li or Na, A is Cl⁻, Br⁻, I⁻, S²⁻, Se²⁻,Te²⁻, CN⁻, NO₂⁻, BH₄⁻, BF₄⁻, AlH₄⁻, BCl₄⁻, or SO₄²⁻ and wherein B is F⁻, O²⁻, H⁻, S²⁻, or OH⁻.

In certain embodiments, the solid electrolyte can alternatively be formed of a polymeric material blended with a suitable salt. In such embodiments, suitable salts can include lithium and sodium salts such as one or more of lithium bis(trifluoromethanesulfonyl)imide (“LiTFSI”) / sodium(I) bis(trifluoromethanesulfonyl)imide (“NaTFSI”), Li/NaClO₄, Li/NaNO₃. Generally, any polymer with resistance to water and alkaline attack can be suitable including, without limitation, polyethylene oxide (“PEO”), polyacrylonitrile (“PAN”), polyvinylidene fluoride (“PVDF”), polyacrylate (“PA”), polymethyl methacrylate (“PMMA”), polycyanoacrylate (“PCA”), aliphatic polycarbonates including poly(ethylene carbonate), poly(propylene carbonate), poly(trimethylene carbonate), and poly(vinylene carbonate).

Generally, the solid electrolytes described herein can be formed as known in the art. For example, physical vapor deposition, sputtering, chemical vapor deposition, chemical solution deposition, plasma assisted chemical vapor deposition, electrochemical deposition, molecular beam epitaxy, ion implantation, atomic layer deposition, or the like can be used to form and deposit the solid electrolyte to the conductive substrate at the desired thickness. As can be appreciated, such deposition techniques can also create a more uniform surface than traditional methods of forming a solid electrolyte.

### Improved Thin Film Protective Coatings For the Solid Electrolyte Surfaces

As can be appreciated, the electrolyte solution of an aqueous metal-air battery is a highly alkaline solution formed of hydroxides, with up to 0.5 wt% hexanol. In the unlikely case that the solid electrolyte is damaged via, scratches, pinholes or cracks, the 0.5 wt% hexanol will slow the hydrogen evolution reaction from water-Na metal contact down to a gentle fizzle and eliminate the possibility of a hydrogen fire. Although the solid electrolyte can resist alkaline attack by hydroxides, one of the limiting factors of metal-air batteries is the breakdown of the solid electrolyte due to corrosion from the highly caustic solution during operation. An improved electrolyte surface coating is described herein that improves the lifespan of both the solid electrolyte and metal-air batteries as a whole. The improved electrolyte surface is a thin film protective coating attached to the solid electrolyte that allows conduction of ions while preventing and/or minimizing the transfer of hydroxide to the surface of the solid electrolyte.

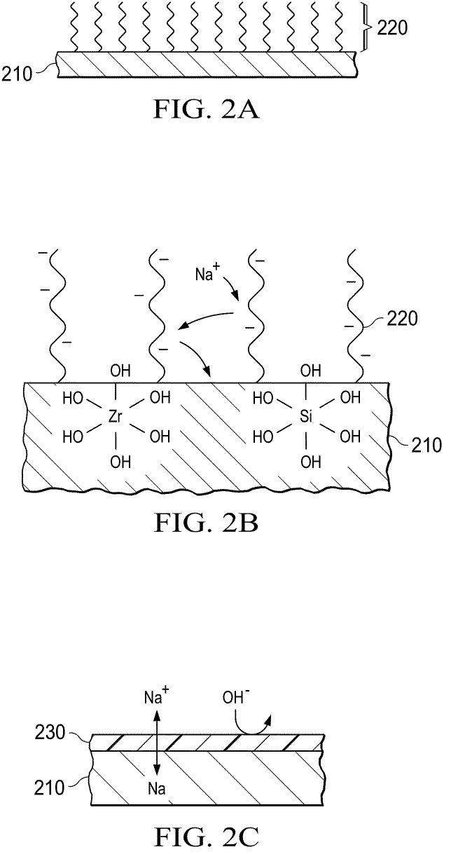

In certain embodiments, the thin film protective coating can be formed by attaching ligands to the surface of the solid electrolyte as depicted in FIG. 2A. Specifically, FIG. 2A illustrates a solid electrolyte 210 having a plurality of ligands 220 attached to the separator 210.

Suitable ligands can include any ligands that can repel hydroxide while allowing transfer of ionic species. For example, suitable ligands can include ether, ketone, ester, carboxylic acid, aldehyde, alkyl halide, carbonate, peroxide, alcohols, SO3—, OSO3—, carboxamide, amidine, amine, ketimine, aldimine, imide, azide, azo, cyanate, isocyanate, nitrate, nitrile, isonitrile, nitrosooxy, nitro, nitroso, oxime, pyridyl, carbamate, thiol, sulfide, disulfide, sulfinyl, sulfonyl, sulfino, sulfo, thiocyanate, Isothiocyanate, carbonothioyl, carbothioic S-acid, carbothioic O-acid, thiolester, thionoester, carbodithioic acid, carbodithio, phosphino, phosphono, and phosphate ligands.

As can be appreciated, such ligands can further be modified in various embodiments. For example, certain ligands can include a terminal group such as a methane group or —CR3 group where the R groups could be mixtures of methane, ethane, propane, etc. Large terminal groups can sterically hinder migration of hydroxide ions through the ligands. In certain embodiments, the terminal group can alternatively be an anionic group. Additionally, or alternatively, such ligands can have side epoxy, thiol, or other groups that can crosslink ligands to either surrounding ligands or to additional locations on the surface of the solid electrolyte.

In certain embodiments, suitable ligands can have various leaving groups and/or silanes on one, or both, ends of the ligand and/or on various side branches of the ligand. Such leaving groups and/or silanes can facilitate attachment of the ligand to the surface of the electrolyte on one end, both ends, or from multiple branches of the ligand. Suitable leaving groups include, without limitation, tosyl, tosylate, triflate, methyl sulfate, mesylate, fluoride, chloride, bromide, iodide, and benzyl/resonating groups. In embodiments where one end of the ligand is attached to the surface of the electrolyte and the other end is free, the terminal group can generally be RO⁻, —NH2, RN⁻H, RCH₂⁻,R₂N⁻, HS⁻, RSe⁻, Cl⁻, Br⁻, I⁻, F⁻, CN⁻, OH⁻, RCO₂⁻, sulfate, carbonate, phosphate, or any other anionic species that repels hydroxides. Ligands with such leaving groups can be attached to the solid electrolyte by applying a solution of the ligands to the solid electrolyte and then washing off or evaporating the carrier solution. In certain embodiments, the solid electrolyte can be functionalized prior to application of the ligands to improve bonding. FIG. 2B depicts covalent attachment of monodentate ligands to a solid electrolyte.

Suitable ligands can be of any length. For example, suitable ligands can be about 1 carbons to about 5000 carbons long or even longer. Generally, longer ligands can provide better resistance to hydroxide migration through the protective layer at the cost of increased ionic resistance. As can be appreciated, the degree of crosslinking and the functional groups contained on the ligands can influence the needed thickness of the protective coating.

Alternatively, in certain embodiments, the improved electrolyte surface can be formed by attachment of a cation exchange membrane as depicted in FIG. 2C where the solid electrolyte 210 has a cation exchange membrane 230 attached to the separator 210. Sometimes called proton exchange membranes, cation exchange membranes are widely used in fuel cells as they are highly conductive to ions while being resistant to hydroxides. Cation exchange membranes include a backbone and a negatively charged and/or highly polarized groups attached to the backbone to repel hydroxides and attract cations.

Suitable cation exchange backbones include hydrocarbon backbones, partially fluorinated backbones, polystyrene backbones, poly(arylene ether sulfone) backbones, poly(arylene ether ketone) backbones, acid-doped polybenzimidazole backbones, poly(vinyl chloride) backbones, and backbones formed of any other plastic. Suitable negatively charged or polarized groups can include nafion, flemion, and aciplex. In certain embodiments, the negatively charged or highly polarized group can be HSO₃, alkyls, halogens alkoxy, CF═CF₂, CN, NO₂ and/or OH groups attached to the backbone either directly or through a suitable bonding moiety such as a benzene moiety. Generally, cation exchange membranes can be attached to the solid electrolyte as known in the art. For example, the surface of the solid electrolyte can be functionalized and then the cation exchange membrane can be attached.

### Dual Oxygen Reduction and Evolution Electrodes

The lifetime and efficiency of a metal-air battery depends, in part, on the lifetime and efficiency of the positive electrode, or cathode, which must reduce dissolved oxygen gas from the air (oxygen reduction reactions (“ORR”)) during discharge and oxidize hydroxide from the catholyte to oxygen gas (oxygen evolution reactions (“OER”). However, cycling between ORR and OER can be detrimental to the lifespan of the cathode catalysts with the oxygen reduction electrode being particularly damaged by cycling to the highly oxidizing potentials of the OER.

Improved metal-air cathode designs that separate the cathode into an oxygen reduction electrode and an oxygen evolution electrode, each with catalysts to improve their efficiency at ORR and OER reactions, are described herein. Collectively called dual oxygen reduction and evolution electrodes, the improved design can improve both the efficiency and lifetime of a metal-air battery. Specifically, it has been discovered that by having separate oxygen reduction electrodes and oxygen evolution electrodes, that the lifespan of each can be improved because cycling does not damage the electrodes and because each can be tailored to a specific reaction by including specific catalysts on the surface of the electrodes. As can be appreciated, the extra weight and surface area required for separate oxygen reduction electrodes and oxygen evolution electrodes can also be mitigated, in part, by making larger capacity batteries as the volume of the battery increases to a cubic power compared to the surface area of the electrodes increasing to a square power.

Suitable catalysts for oxygen evolution electrodes and oxygen reduction electrodes include perovskites, spinels; certain layered materials; layered double hydroxides; conductive carbons; metals and their oxides, hydroxides, oxyhydroxides, carbides, nitrides, phosphates, sulfides, and phosphides; redox mediators; and molecular inorganic frameworks.

Suitable perovskite-type catalysts can have the chemical formula ABC₃ wherein A is one or more of H, Li, Na, K, Rb, Cs, Fr, Be, Mg, Ca, Sr, Ba, Ra, Sc, Y, and Ln(rare earth elements); B is a transition metal (e.g., Sc, Ti, V, Cr, Mn, Fe, CO, Ni, Cu, Zn, Y, Zr, Nb, Mo, Tc, Ru, Rh, Pd, Ag, Cd, Hf, Ta, W, Re, Os, Ir, Pt, Au, or Hg); and C is one or more of H, C, N, O, F, S, Cl, As, Se, Br, I, Rh, and Pd.

Suitable spinel-type catalysts can have the chemical formula AB₂O₄ where A is one or more of Li, Na, K, Rb, Cs, Fr, Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, Hg; and B is one or more of Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, Hg.

Suitable layered materials can have the chemical formula M₁₋ₓM'O₂ where M is one or more of Li, Na, K, Rb, Cs, Fr; M′ is one or more of Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, and Hg; and X is 0 or 1.

Suitable layered double hydroxides can have the formula MOOH where M is one or more of Li, Na, K, Rb, Cs, Fr, Be, Mg, Ca, Sr, Ba, Ra, Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, and Hg. Layered double hydroxides can optionally include interlayer anions such as CO₃²⁻,C₂O₄²⁻, SO₄²⁻, and NO.

Suitable conductive carbon-based catalysts include pure carbon based catalysts (e.g., graphite, carbon nanotubes, graphene, glassy carbon, etc.) as well as carbon doped with one or more of Fe, Co, Mn, O, N, F, S, P and B.

Suitable metal oxides, hydroxides, oxyhydroxides, carbides, nitrides, phosphates, sulfides, and phosphides can vary. For example, suitable metals can include one or more of Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, Hg, Bi, Pb, Po, Tl, Sb, Te, Sn, In, As, Se,Ge, Ga, Al, and Si. Suitable metal carbides and metal nitrides include metal carbides and nitrides of Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, and Hg. Suitable metal phosphates include those of formula Aₗ₋ₓBPO₄ wherein A is one or more of Li, Na, K, Rb, Cs, and Fr; B is one or more of Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, and Hg; and x is 0 to 1. Suitable metal hydroxides, sulfides, and phosphides include those formed of one or more of Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, and Hg.

Suitable redox mediators can include iodine and bromine mediators such as I₂, I⁻,I₃⁻, IO₃, and Br₂.

Metal inorganic frameworks are a type of coordination polymer having a metal ion or cluster cording to various inorganic ligands. Any suitable metal inorganic framework can be used as a catalyst for the oxygen evolution electrode or oxygen reduction electrode described herein.

Particularly suitable catalysts for the oxygen reduction electrode include metal nitrides as they are both catalytically efficient at reducing oxygen gas and electrically conductive. For example, in certain embodiments, iron nitride can be used as the catalyst for the oxygen reduction electrode. The electrical conductivity allows the oxygen reduction catalyst to double as the current collector for a metal-air battery without requiring a separate conductive additive. Similarly, particularly suitable catalysts for the oxygen evolution electrode includes metal oxides, hydroxides, oxyhydroxides of metals including nickel, iron, manganese, and copper. For example, a suitable catalyst for the oxygen evolution catalyst can be a nickel iron oxyhydroxide having nickel and iron in a roughly 3:1 ratio (e.g., Ni_{0.75}Fe_{0.25}OOH).

In certain embodiments, the stability of the oxygen evolution electrodes and oxygen reduction electrodes can be further enhanced by dissolving one or more of nickel ions, iron ions, manganese ions, copper ions, anode ions, halogen ions, solid electrolyte constituents and ions in the electrolyte. By dissolving additional ions in the electrolyte, the components are in equilibrium with the solution so there will be no driving force for their elements to dissolve in solution.

### Active Gas Diffusion Electrodes

To further improve the oxygen evolution electrode and oxygen reduction electrode, improvements to the manufacture of the electrode were further developed.

According to one embodiment, a stable, low cost, active gas diffusion electrode can be formed by using a blowing agent in combination with an electrically conductive catalyst and a polymer stable against the catholyte solution. Use of the blowing agent can allow the pores within the electrode to quickly expand from the release of gases from the blowing agent during manufacture and can allow for more efficient reduction and evolution of oxygen from more three phase (gas-liquid-solid) interfaces.

Generally, such electrodes can be formed by mixing each of the components together, forming a thin film, and then activating the blowing agent to cause foaming of the mixture and thereby form an electrode having a high surface area. In certain such embodiments, the components can each be supplied as a powder, mixed together, melted, and then extruded and/or rolled into a thin film.

Other than the addition of the blowing agent, the components of the improved electrode can generally be the same as previously described components. For example, the electrically conductive catalyst can be the same as the catalysts in the dual oxygen reduction and evolution electrodes previously described herein. For example, the catalyst can be a metal nitride, a metal, a metal oxide, a metal hydroxide, a metal oxyhydroxide, conductive carbons, etc. The polymer can be any polymer that is chemically stable with the electrolyte such as the polymers previously described as being usable with the solid electrolyte.

Suitable blowing agents generally encompass any known blowing agents. Particularly suitable blowing agents can be acid activated blowing agents such as sodium bicarbonate and sodium carbonate which produce carbon dioxide gas upon contact with an acid. As can be appreciated however, other blowing agents can also be used as known in the art. Alternatively, a blowing agent can be omitted in favor of dissolving large quantities of a gas in the molten plastic precursor and then subjecting the thin film to vacuum to cause bubbling.

In other embodiments, electrodes with high surface area can alternatively be formed by depositing the electrically conductive catalysts onto a surface inherently having a high surface area. In such embodiments, examples of such surfaces can include meshes, screens, and micromachined surfaces. The electrically conductive catalysts can be applied to the surfaces using chemical solution deposition, physical vapor deposition, sputtering, chemical vapor deposition, plasma assisted chemical vapor deposition, electrochemical deposition, electroless deposition, molecular beam epitaxy, ion implantation, atomic layer deposition, or the like.

### Improved Metal-Air Battery Cell Structures

Improved metal-air batteries can incorporate one or more of the improvements described herein. In certain embodiments, particularly suitable metal-air batteries are aqueous metal-air batteries including a metal anode, at least one air cathode, a solid electrolyte, and an aqueous electrolyte layer (sometimes called a catholyte layer). As can be appreciated, many variations to this design are possible.

For example, in certain embodiments, the metal anode can be formed in-situ by plating onto the current collector during charging of the metal-air battery. Such an anode-less battery can enable easier, safer manufacturing and transportation of a metal-air battery particularly when the anode is an alkali metal such as lithium or sodium which violently reacts to water exposure. In such embodiments, the metal-air battery cell can be assembled with the solid electrolyte being attached to the current collector. Charging of the battery can then electroplate, or otherwise deposit, the metal anode onto the current collector. For example, a sodium air battery can plate sodium metal onto the current collector by reducing sodium ions disassociated from sodium hydroxide in the electrolyte to metallic sodium on the current collector to thereby form the anode.

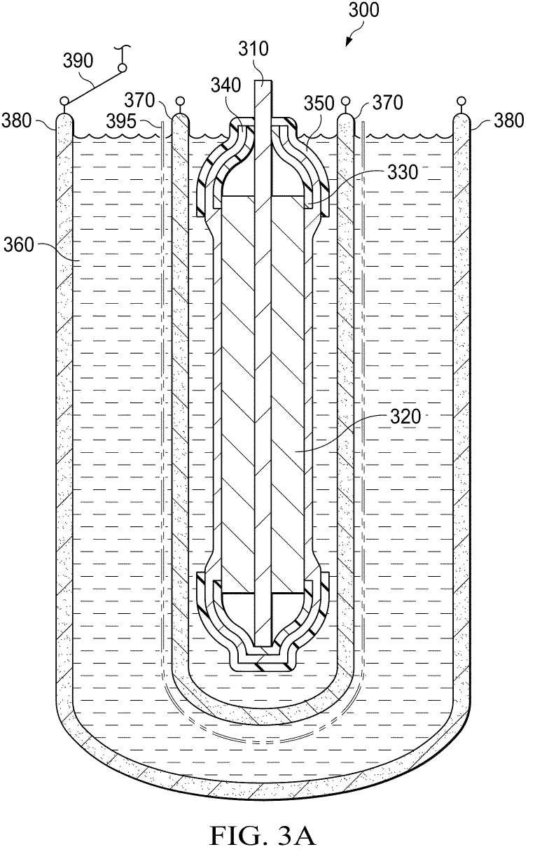

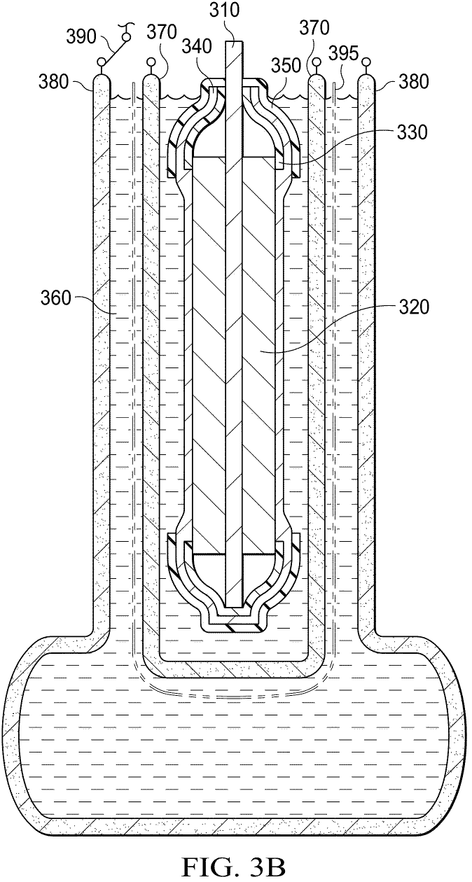

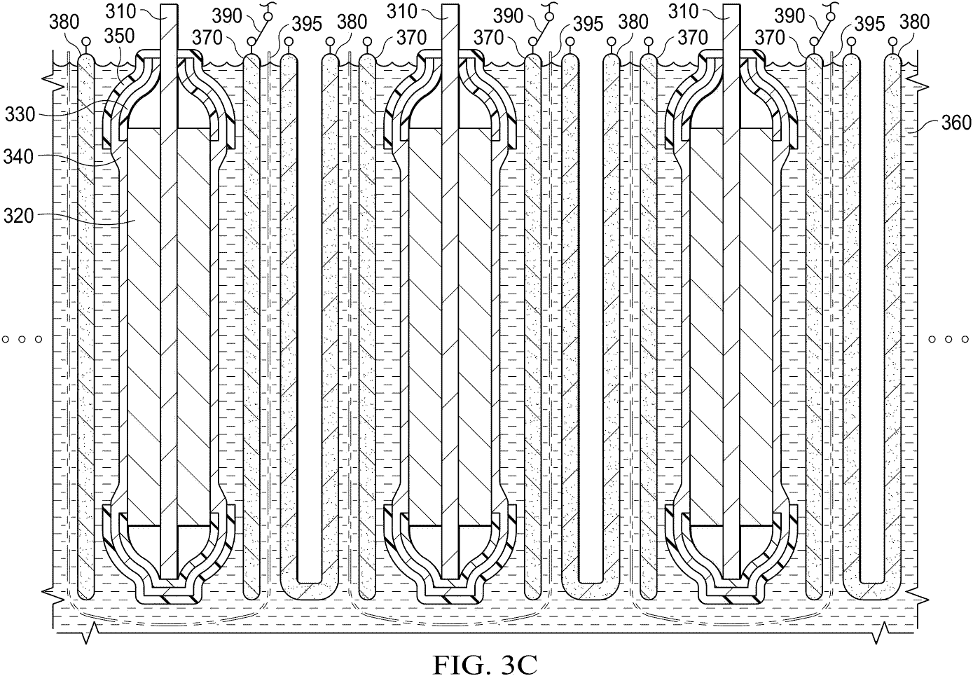

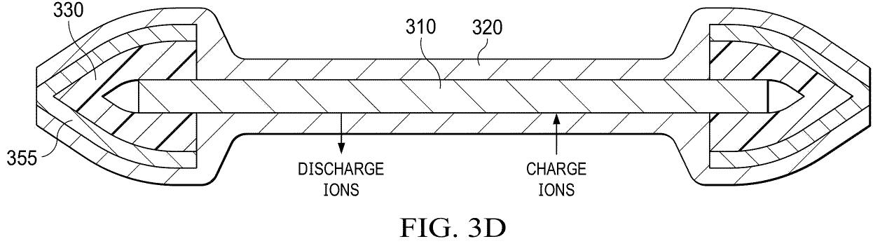

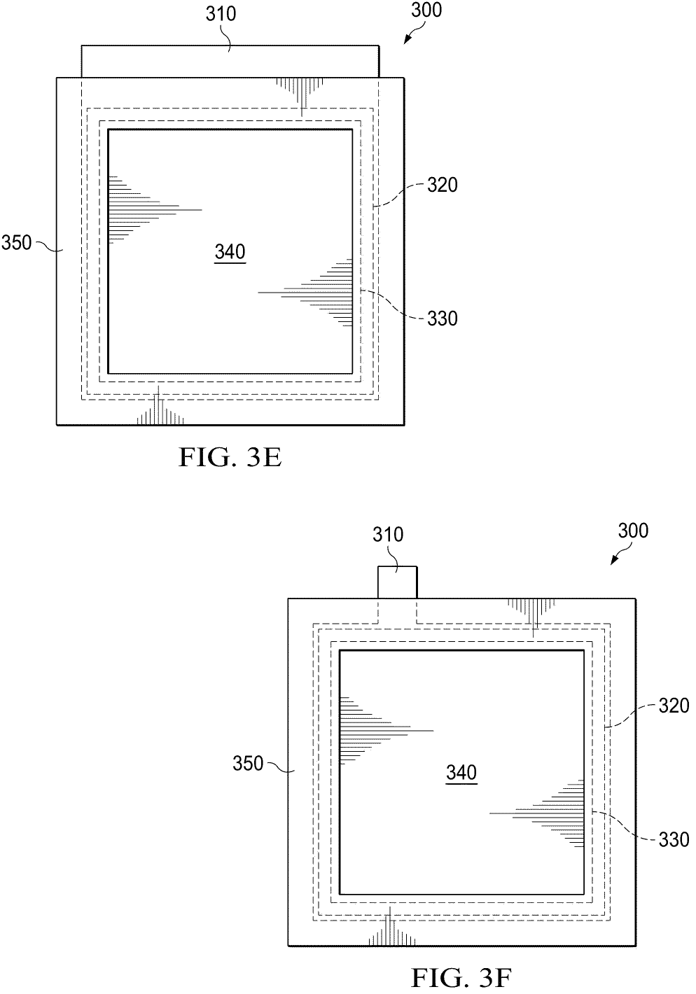

An example side view of an improved metal-air battery as described herein is depicted in FIG. 3A. As depicted in FIG. 3A, the battery 300 can include a current collector 310, an anode 320 surrounding the current collector 310, a solid electrolyte 340 bonded to the anode 320, an aqueous electrolyte 360 in fluid contact and surrounding the solid electrolyte 340, an oxygen evolution electrode 370 in the aqueous electrolyte 360, and an oxygen reduction electrode 380 acting as an outer wall for the battery 300. The battery 300 further includes a switch 390 to select between the oxygen evolution electrode 370 and the oxygen reduction electrode 380 which facilities switching the battery 300 from a charging mode to discharging mode and vice versa. Although the switch 390 is depicted as a mechanical switch, the switch 390 can be an electronic switch automatically operable through the use of a transistor or the like in certain embodiments. In certain embodiments, the switch can also automatically control a heater element to bring the battery to an optimal temperature for charging or discharging as necessary. The battery 300 is further depicted as including a polymer border 330 that surrounds the current collector 310 and a protective covering 350. The polymer border 330 can help position and stabilize the solid electrolyte 340. The polymer border can also relieve stress at the edges as the sodium metal electroplates and lifts the solid electrolyte 340 away from the current collector 310. The optional protective covering 350 can help prevent migration of the aqueous electrolyte 360 from reaching the anode 320 and current collector 310 at the ends of the battery 300. The optional protective coating 350 can also help prevent migration of water and hydroxide ion from reaching the anode 320 and current collector 310. An additional separator 395 is included to ensure that the oxygen evolution electrode 370 and the oxygen reduction electrode 380 do not make electrical contact with one another. The additional separator 395 can be formed of a suitable polymeric material such as polypropylene or polyethylene.

Further variations of exemplary metal-air batteries are further depicted in FIGS. 3B to 3F. FIG. 3B depicts a battery having a larger amount of aqueous electrolyte 360 stored under the negative electrode rather than between the oxygen reduction and oxygen evolution electrodes. Such a design can decrease the distance from the oxygen reduction electrode 380 to the negative electrode to minimize resistive losses in the catholyte while still allowing for ample solvent to dissolve discharge products and maintain a high energy density.

FIG. 3C depicts a cross-sectional view of multiple metal-air batteries in parallel using a common pool of aqueous electrolyte 360. In FIG. 3C, multiple cells share the same oxygen reduction electrodes 380 and oxygen evolution electrodes 370. As can be appreciated, the design of FIG. 3C is similar to a lead-acid battery (not shown) where an exterior case holds the individual cells and the electrolyte solution. Such a design facilitates the construction of a module or pack with reduced mechanical complexity and weight to provide a higher energy density.

FIG. 3D depicts a cross section of the negative electrode compartment in the discharged state (without the metal anode) with the solid electrolyte 320 surrounding the current collector and polymer border 330 and metal coating 355.

FIGS. 3E and 3F depict top views of a metal-air battery negative electrode showing the arrangement of the current collector 310 and solid electrolyte 330. The size of the current collector tab 310 varies between FIGS. 3E and 3F.

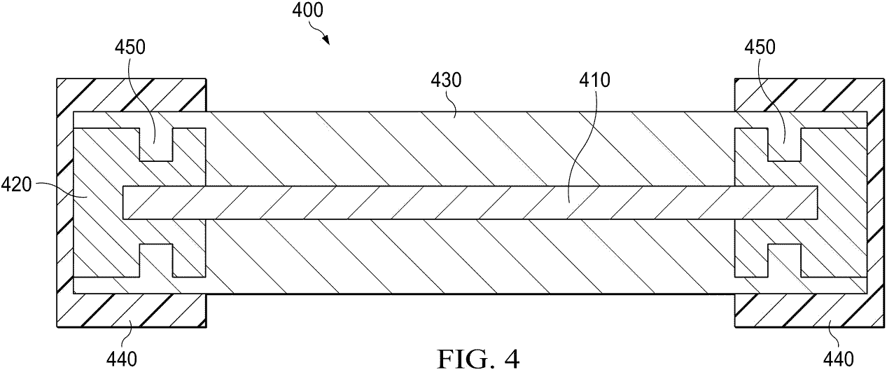

FIG. 4 depicts a cross sectional view of the core of another metal-air battery negative electrode 400 with the parts illustrated in exaggerated size for visibility. The battery core 400 includes a current collector 410, an anode (not visible) plated on the current collector 410, a polymer border 420, a solid electrolyte 430, and an additional polymer border 440 surrounding the edge of the solid electrolyte 430. The polymer border 420 may be formed of any suitable polymer that is non-reactive to aqueous hydroxide solutions and alkali metals such as parylene. In certain embodiments, the polymer border 420 may be notched 450 as depicted in FIG. 4. The notch 450 (shown in exaggerated detail) can provide additional surface area for the solid electrolyte 430 to attach and latch onto. In certain embodiments, a metal coating (not shown) can additionally overlay the polymer border 420. If the polymer border, is notched, the metal coating can similarly include such a notch.

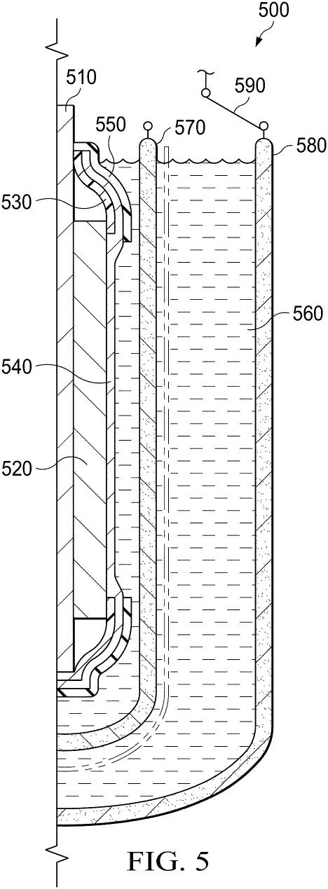

FIG. 5 depicts a side sectional view of an aqueous metal-air battery 500 according to another embodiment. The aqueous metal-air battery 500 of FIG. 5 is similar to the metal-air battery of FIG. 3A but is formed in a layered arrangement rather than a symmetric arrangement. The aqueous metal-air battery 500 includes a current collector 510, an anode 520 above the current collector 510, a solid electrolyte 540 bonded to the anode 520, an aqueous electrolyte 560 in fluid contact above the solid electrolyte 540, an oxygen evolution electrode 570 in the aqueous electrolyte 540, and an oxygen reduction electrode 580 acting as an outer wall for the battery 500. The battery 500 further includes a switch 590 to select between the oxygen evolution electrode 570 and the oxygen reduction electrode 580. The battery 500 is further depicted as including a polymer border 530 that surrounds the current collector 510 and a protective covering 550.

As can be appreciated, certain elements such as polymer border and the protective covering can be optional in various embodiments.

Generally, the metal-air batteries described herein can include one or more of the improvements described herein. For example, the improvements to the solid electrolyte and its surface can be used in non-aqueous metal-air batteries. Alternatively, an aqueous metal-air battery can include the improved solid electrolyte and solid electrolyte surfaces described herein but use a conventional air cathode that performs both the oxygen evolution and oxygen reduction reactions or use a cathode formed without a blowing agent.

### EXAMPLES

### Solid Electrolyte

A Nasicon solid electrolyte was formed on stainless steel to evaluate the performance of the solid electrolyte. The Au electrodes sputtered onto the solid electrolyte were measured to have a size of 0.079 cm² and solid electrolyte built from multiple layers approximately 300 nm thick each.

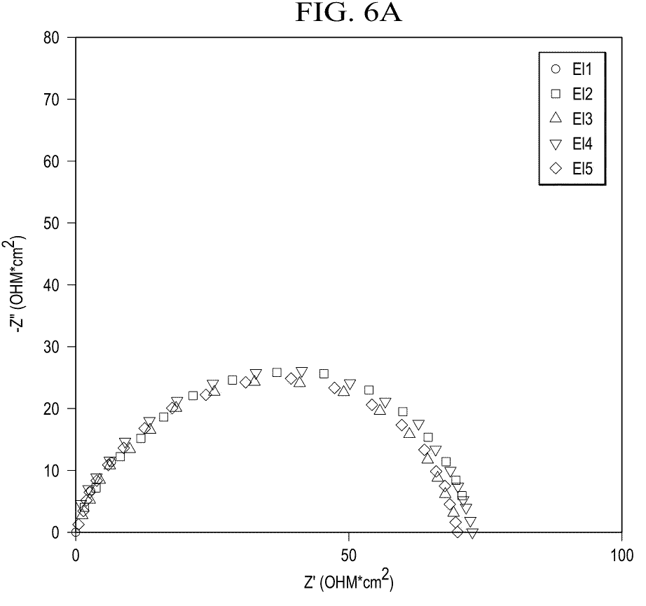

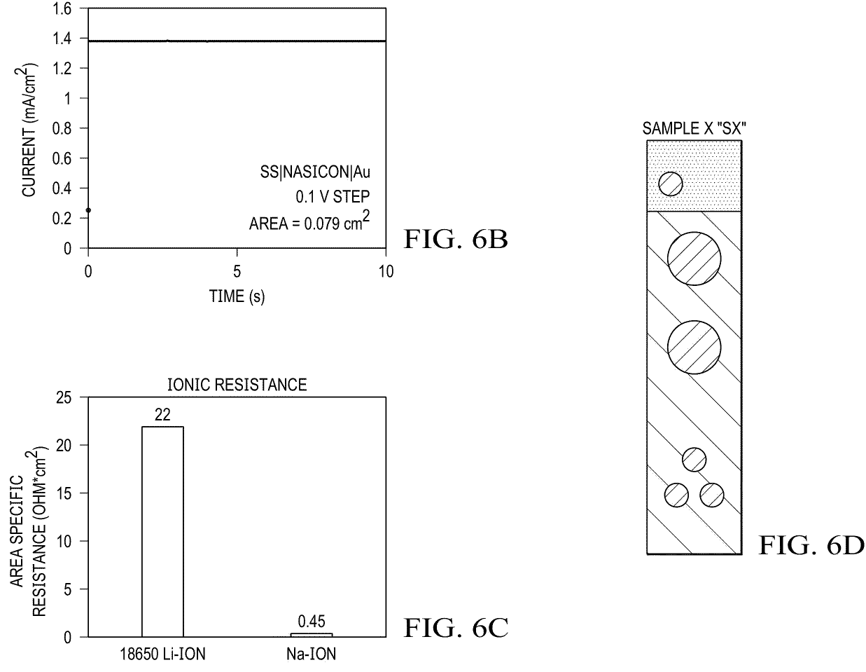

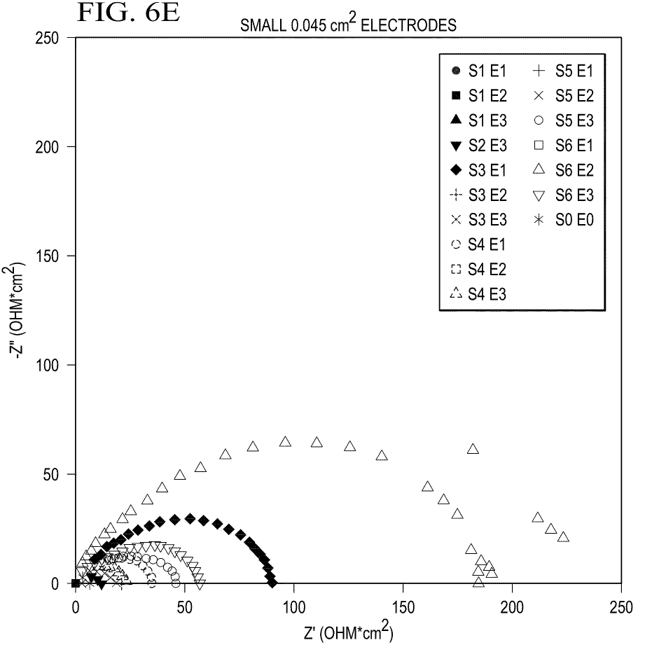

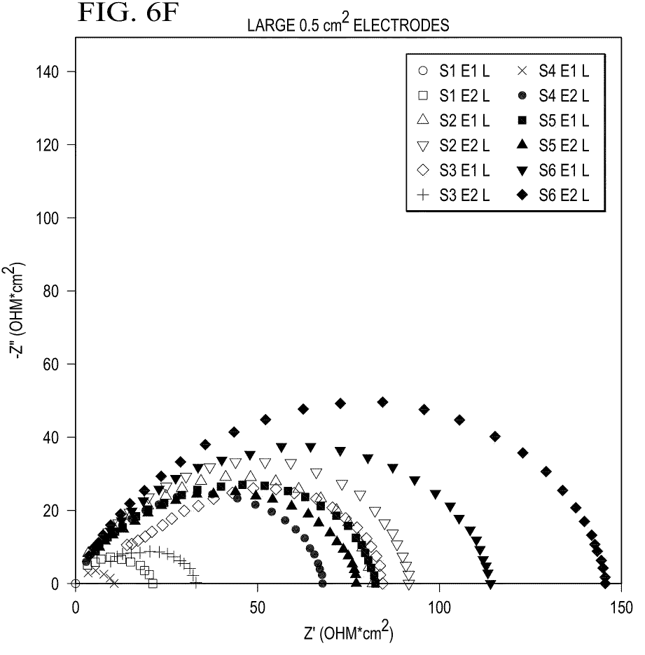

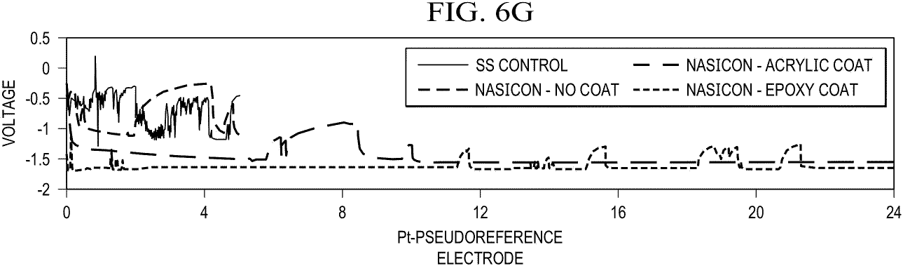

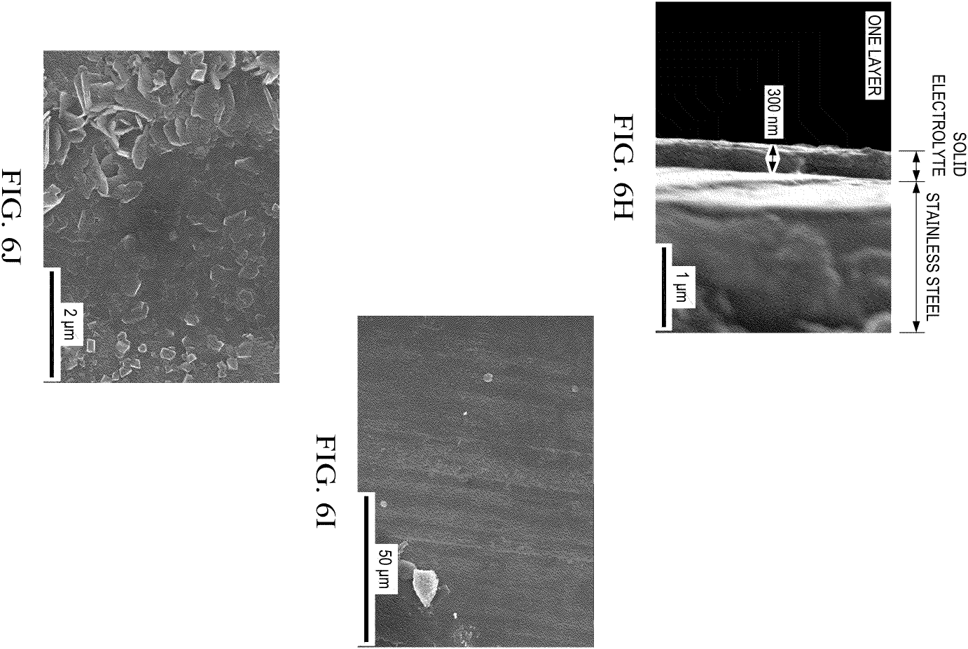

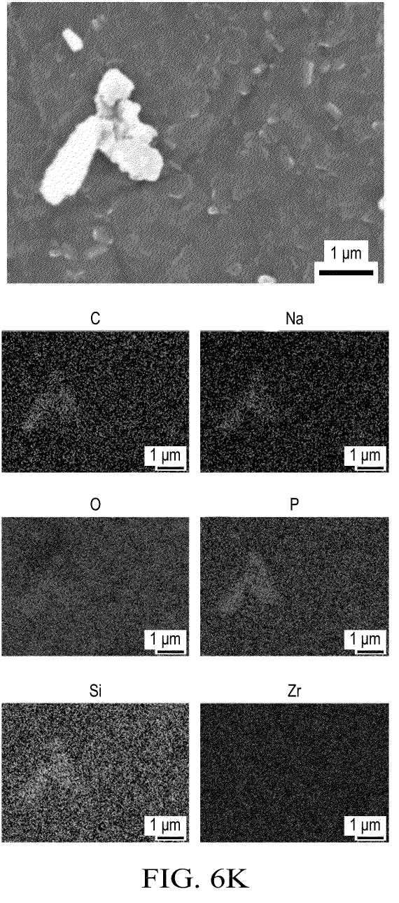

Electrochemical Impedance Spectroscopy (“EIS”) was performed on the solid electrolyte with electrodes placed as depicted in FIG. 6D. FIGS. 6A, 6E, and 6F depict the EIS results of the solid electrolyte with the semicircle shape, modeled as a resistor and capacitor in parallel, indicates a pinhole free film. The lack of a vertical or 45° angle tail after the high impedance x-intercept indicates that the films are so thin that electrons are able to pass through the film which can be suppressed by depositing more and thicker layers of solid electrolyte. This also suggests that the ionic area specific resistance is incredibly small and near the zero intercept. FIG. 6B depicts the current vs. time profile of the solid electrolyte from a 0.1 V constant potential step to measure its electronic resistance and subtracting the FIG. 6B electronic resistance from the total resistance from the high impedance x-intercept in FIG. 6A gives the area specific ionic resistance as shown in FIG. 6C. As seen in FIG. 6C, the solid-electrolyte described herein exhibits substantially less ionic resistance than a comparable 18650 lithium ion battery. FIG. 6G depicts the open circuit potential vs. a Pt pseudo-reference electrode of a stainless steel (ss) foil control, ss coated with a Nasicon solid electrolyte and a ss-Nasicon coated foil covered with either an epoxy or acrylic coating in 19 M NaOH. This demonstrates that adding a chemically inert film onto of the solid electrolyte can provide some corrosion inhibiting properties.

Electron microscopy of the solid electrolyte is depicted in FIGS. 6H to 6K. As seen in FIG. 6H, the thickness of the separator is 300 nm and it has a solid, very uniform surface with imperfections about 2 microns or less in size as depicted in FIGS. 6I and 6J. Atomic prevalence is depicted in FIG. 6K.

The dimensions and values disclosed herein are not to be understood as being strictly limited to the exact numerical values recited. Instead, unless otherwise specified, each such dimension is intended to mean both the recited value and a functionally equivalent range surrounding that value.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent articles by those of ordinary skill in the art. Rather it is hereby intended the scope be defined by the claims appended hereto.

It should be understood that certain aspects, features, structures, or characteristics of the various embodiments can be interchanged in whole or in part. Reference to certain embodiments mean that a particular aspect, feature, structure, or characteristic described in connection with certain embodiments can be included in at least one embodiment and may be interchanged with certain other embodiments. The appearances of the phrase “in certain embodiments” in various places in specification are not necessarily all referring to the same embodiment, nor are certain embodiments necessarily mutually exclusive of other certain embodiments. It should also be understood that the steps of the methods set forth herein are not necessarily required to be performed in the orders described, and the order of the steps of such methods should be understood to be merely exemplary. Likewise, additional steps can be included in such methods, and certain steps may be omitted or combined, in methods consistent with certain embodiments.

What is claimed is:

1. A metal-air battery comprising:
an anode formed from a metal or metal alloy, wherein the metal or metal alloy comprise one or more of lithium, sodium, potassium, rubidium, cesium, francium, zinc, and aluminum;
a solid electrolyte attached to the anode; and
an aqueous electrolyte; and
wherein the aqueous metal-air battery further comprises one or more of:
a protective thin film coating a surface of the solid electrolyte; and
an oxygen evolution electrode and an oxygen reduction electrode, each comprising a catalyst.

2. The metal-air battery of claim 1 comprises the protective thin film on a surface of the solid electrolyte.

3. The metal-air battery of claim 2, wherein the protective thin film comprises a plurality of ligands or a cation exchange membrane.

4. The metal-air battery of claim 3, wherein the plurality of ligands comprise one or more of ether, ketone, ester, carboxylic acid, aldehyde, alkyl halide, carbonate, peroxide, alcohols, RS03-, ROS03-, carboxamide, amidine, amine, ketimine, aldimine, imide, azide, azo, cyanate, isocyanate, nitrate, nitrile, isonitrile, nitrosooxy, nitro, nitroso, oxime, pyridyl, carbamate, thiol, sulfide, disulfide, sulfinyl, sulfonyl, sulfino, sulfo, thiocyanate, Isothiocyanate, carbonothioyl, carbothioic S-acid, carbothioic O-acid, thiolester, thionoester, carbodithioic acid, carbodithio, phosphino, phosphono, and phosphate ligands.

5. The metal-air battery of claim 4, wherein the plurality of ligands comprise an anionic group or a steric hindering group at the distal end.

6. The metal-air battery of claim 1, wherein the solid electrolyte has a thickness of less than about 50 micrometers.

7. The metal-air battery of claim 6, wherein the solid electrolyte has a multi-layer structure.

8. The metal-air battery of claim 1, wherein the solid electrolyte has an ionic resistance of about 0.25 Ω/cm² to about 5 Ω/cm².

9. The metal-air battery of claim 1, wherein the ceramic material is a Nasicon-type ceramic.

10. The metal-air battery of claim 9, wherein the ceramic material comprises a Nasicon-type ceramic, a Lisicon-type ceramic, a garnet-type ceramic, a perovskite-type ceramic, a NaPON-type ceramic, a LiPON-type ceramic, a Li3N-type ceramic, a Na₃N-type ceramic, an argyrodite-type ceramic, an anti-perovskite type ceramic, a sodium-beta-alumina ceramic, a lithium-beta-alumina ceramic, a potassium-beta-alumina ceramic, a phosphate-type ceramic, or a borate-type ceramic ceramic.

11. The metal-air battery of claim 10, wherein the solid electrolyte comprises a Nasicon-type ceramic.

12. The metal-air battery of claim 1, wherein the solid electrolyte comprises one or more of a lithium salt and/or a sodium salt blended into one or more of polyethylene oxide (“PEO”), polyethylene oxide (“PEO”), polyacrylonitrile (“PAN”), polyvinylidene fluoride (“PVDF”), polyacrylate (“PA”), polymethyl methacrylate (“PMMA”), polycyanoacrylate (“PCA”), poly(ethylene carbonate), poly(propylene carbonate), poly(trimethylene carbonate), and poly(vinylene carbonate).

13. The metal-air battery of claim 1 comprises the oxygen evolution electrode and the oxygen reduction electrode; and
wherein the catalyst of the oxygen reduction electrode comprises a metal nitride.

14. The metal-air battery of claim 1 comprises the oxygen evolution electrode and the oxygen reduction electrode; and
wherein the catalyst of the oxygen evolution electrode comprises an oxide, hydroxide or oxyhydroxides of one or more of nickel, iron, manganese, and copper.

15. The metal-air battery of claim 14 wherein the aqueous electrolyte comprises hydroxides of the anode and further comprises one or more nickel ions, iron ions, manganese ions, copper ions, anode ions, halogen ions, and solid electrolyte constituents and ions.

16. The metal-air battery of claim 1, comprises the oxygen evolution electrode and the oxygen reduction electrode; and
wherein each of the oxygen evolution electrode and the oxygen reduction electrode each comprise a gas-diffusion layer.

17. The metal-air battery of claim 1 comprises:
the protective thin film on a surface of the solid electrolyte; and
the oxygen evolution electrode and the oxygen reduction electrode.

18. The metal-air battery of claim 17, wherein the oxygen reduction electrode forms an outer shell of the aqueous metal-air battery.

19. The metal-air battery of claim 17 further comprises a switch to select between a charge or discharge cycle.

20. The metal-air battery of claim 1 is a sodium air battery and wherein the aqueous electrolyte comprises sodium hydroxide.
